(19) United States
(12) Patent Application Publication
(10) Pub. No.: US 2021/0200156 A1
(43) Pub. Date: Jul. 1, 2021

(54) Watch

(71) Applicant: Seiko Epson Corporation, Toyko (JP)

(72) Inventors: Koki HAYASHI, Shiojiri (JP); Yoshihiro NAITO, Okaya (JP)

(21) Appl. No.: 17/131,853

(22) Filed: Dec. 23, 2020

(30) Foreign Application Priority Data
Dec. 26, 2019 (JP) 2019-235884

(51) Int. Cl. G04B 37/10; G04B 3/04

(52) U.S. Cl. CPC G04B 37/106; G04B 3/041

(57) ABSTRACT

A watch includes: a crown including a head portion and a shaft portion; a stem pipe including a first surface that includes an insertion hole through which the shaft portion is inserted and has a distance from a surface of the shaft portion as a first distance in cross-sectional view, and a second surface that is provided at a position closer to an end portion of the insertion hole than the first surface and has a distance from the surface of the shaft portion as a second distance larger than the first distance; a packing disposed between the surface of the shaft portion and the first surface; and a metal ring that is disposed between the surface of the shaft portion and the second surface and is in contact with the packing.

The present application is based on, and claims priority from JP Application Serial Number 2019-235884, filed Dec. 26, 2019, the disclosure of which is hereby incorporated by reference herein in its entirety.

### BACKGROUND

### 1. Technical Field

The present disclosure relates to a watch having a water resistant function.

### 2. Related Art

In a watch having a water resistant function, it is necessary to ensure water resistant performance of an operation unit such as a crown. In particular, a saturated diving watch such as a diver's watch that can be used for diving work is required to have a water resistant structure that can withstand a water pressure of 20 atm or more, for example.

JP-A-52-149155 discloses a watch having a water resistant structure in which a synthetic rubber packing and a packing holding ring made of a synthetic resin are provided inside a stem pipe, and the packing holding ring is pushed into an inner wall of a crown. A groove portion for bitting and fixing the packing holding ring that holds the synthetic rubber packing is formed at an inner end portion of the stem pipe.

However, in the water resistant structure of JP-A-52-149155, there is a problem that it is difficult to secure water resistant performance required for a saturated diving watch. Specifically, since the packing is held by the packing holding ring made of a synthetic resin and the packing holding ring is fixed by bitting, there is a risk that the packing holding ring may come off due to a pressure change under high pressure in the deep sea.

Therefore, an object of the present disclosure is to provide a watch having a water resistant structure with which excellent water resistant performance can be obtained.

### SUMMARY

A watch includes: a crown including a head portion and a shaft portion; a stem pipe including a first surface that includes an insertion hole through which the shaft portion is inserted and has a distance from a surface of the shaft portion as a first distance in cross-sectional view, and a second surface that is provided at a position closer to an end portion of the insertion hole than the first surface is and has a distance from the surface of the shaft portion as a second distance larger than the first distance; a packing disposed between the surface of the shaft portion and the first surface; and a metal ring that is disposed between the surface of the shaft portion and the second surface and faces the packing.

### BRIEF DESCRIPTION OF THE DRAWINGS

FIG. 1 is a schematic plan view showing a configuration of a watch.

FIG. 2 is a schematic side cross-sectional view of a main portion showing a configuration of a crown.

FIG. 3 is a schematic side cross-sectional view of a main portion showing a configuration of a stem pipe.

FIG. 4 is a schematic perspective view showing the configuration of the stem pipe.

FIG. 5 is an exploded perspective view showing the configuration of the stem pipe.

### DESCRIPTION OF EXEMPLARY EMBODIMENTS

### Embodiments

In the present embodiment, a characteristic example of an underwater diver's watch will be described with reference to the drawings.

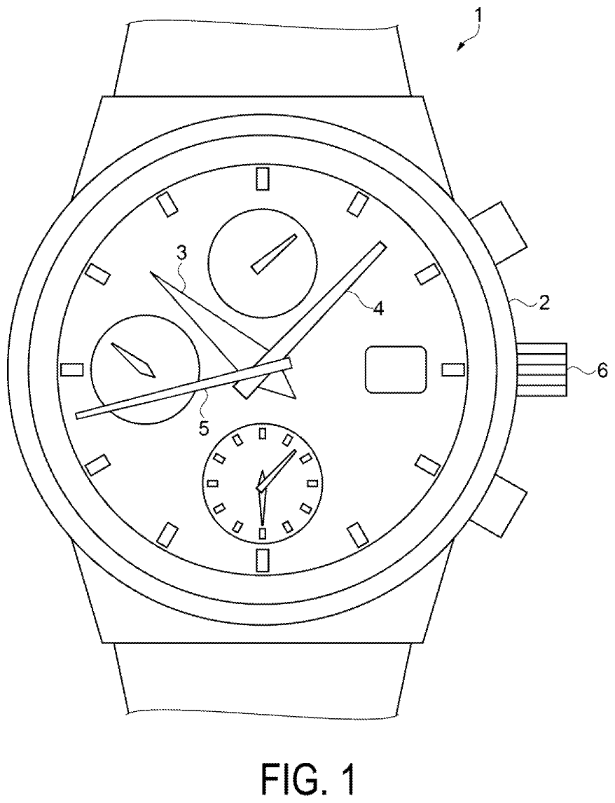

As shown in FIG. 1, a watch 1 incudes a body 2. An hour hand 3, a minute hand 4, and a second hand 5 are disposed on the body 2. The hour hand 3, minute hand 4, and second hand 5 indicate the hours, minutes, and seconds of the current time, respectively. The watch 1 includes a crown 6 on a right side surface of the body 2 in the figure. The crown 6 can be pulled out a predetermined length rightward in the figured. The crown 6 is rotatable after being pulled out. An operator can adjust a position of the minute hand 4 by rotating the crown 6. After adjusting the position of the minute hand 4, the operator pushes the crown 6 toward the body 2. The minute hand 4 cannot be adjusted in a state in which the crown 6 has been pushed into the body 2. Further, the operator can rotate and lock the crown 6 so that the crown 6 cannot be pulled out.

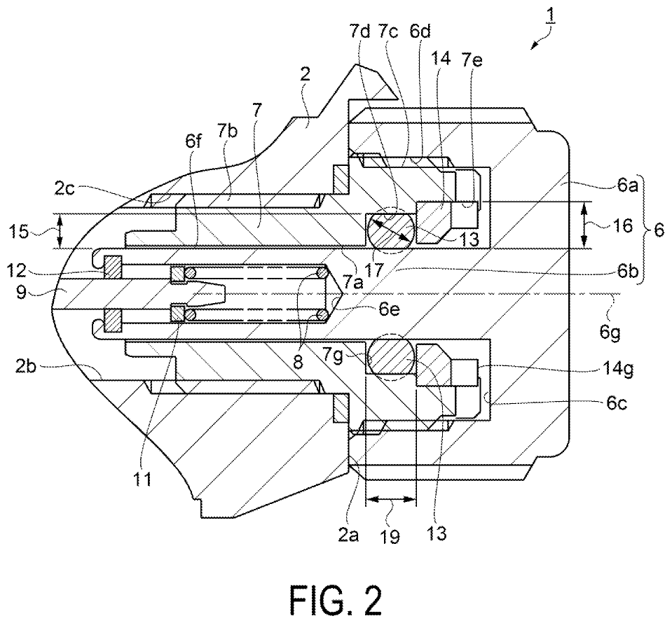

As illustrated in FIG. 2, the body 2 includes a lateral hole 2b on a side surface 2a thereof. A first female screw 2c is formed in the lateral hole 2b. A cylindrical stem pipe 7 is inserted into the lateral hole 2b. The stem pipe 7 includes an insertion hole 7a coaxial with the lateral hole 2b. The crown 6 has a head portion 6a and a shaft portion 6b. The shaft portion 6b is inserted into the insertion hole 7a. The insertion hole 7a is a bearing of the shaft portion 6b. When the head portion 6a rotates, the crown 6 rotates about the shaft portion 6b. A surface 6f of the shaft portion slides with the insertion hole 7a, so that the shaft portion 6b can move along an axis 6g of the shaft portion 6b relative to the stem pipe 7.

The stem pipe 7 is provided with a first male screw 7b and a second male screw 7c on an outer circumferential side thereof. The first male screw 7b is screwed to the first female screw 2c of the body 2. A method of fixing the stem pipe 7 to the body 2 may be brazing. The head portion 6a of the crown 6 includes a recessed portion 6c on the shaft portion 6b side. The recessed portion 6c includes a second female screw 6d on a surface facing the surface 6f of the shaft portion. When the crown 6 is rotated while being pushed into the body 2, the second female screw 6d is screwed onto the second male screw 7c. The crown 6 is screwed onto the stem pipe 7. When diving, the crown 6 is locked by screwing the crown 6 onto the stem pipe 7, so that high water resistant performance can be ensured.

In the shaft portion 6b, the crown 6 includes a winding stem insertion hole 6e coaxially provided in the shaft portion 6b. A spring 8 and a winding stem 9 are inserted into the winding stem insertion hole 6e. A first C-ring 11 is fixed to the winding stem 9. The spring 8 presses the first C-ring 11 in the winding stem insertion hole 6e. The winding stem 9 is elastically biased by the spring 8.

A second C-ring 12 is fixed to the winding stem insertion hole 6e at a left end of the winding stem insertion hole 6e in the figure. An inner circumferential surface of the second C-ring 12 slides on the winding stem 9. When the crown 6 is pulled out, the second C-ring 12 abuts the first C-ring 11. The winding stem 9 is pulled out through the first C-ring 11. When the crown 6 rotates, torque is transmitted to the winding stem 9 via the second C-ring 12 and the first C-ring 11, and thus the winding stem 9 rotates.

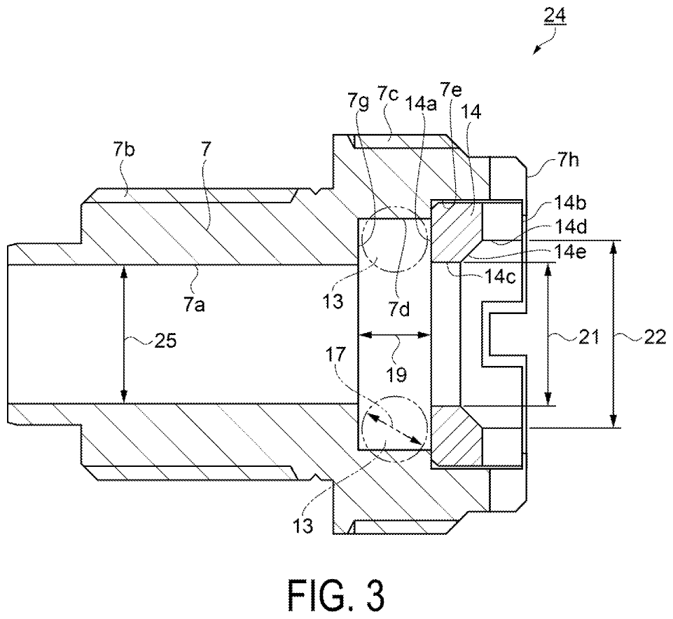

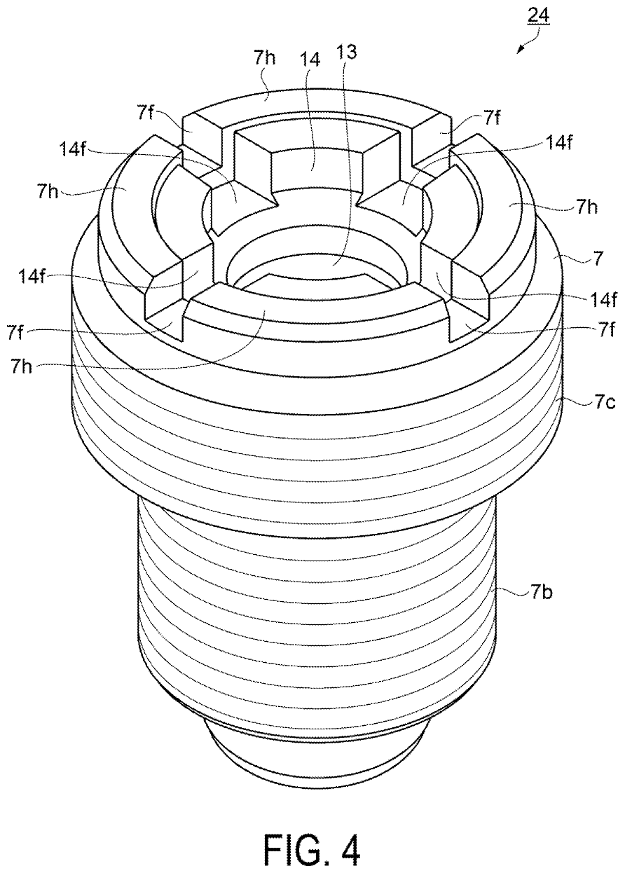

As shown in FIGS. 3 and 4, the stem pipe 7 has a first surface 7d and a second surface 7e on the head portion 6a side of the crown 6. The second surface 7e is provided at a position closer to an end portion of the insertion hole 7a than the first surface 7d is. Accordingly, the first surface 7d is positioned between the insertion hole 7a and the second surface 7e. A packing 13 is disposed between the surface 6f of the shaft portion and the first surface 7d. A metal ring 14 is disposed between the surface 6f of the shaft portion and the second surface 7e. The metal ring 14 faces the packing 13. In cross-sectional view of a cross-section passing through the axis 6g of the shaft portion, a distance between the surface 6f of the shaft portion and the first surface 7d is a first distance 15. A distance between the surface 6f of the shaft portion and the second surface 7e is a second distance 16. The second distance 16 is larger than the first distance 15.

A shape of the packing 13 is a ring shape, and a cross-sectional shape of the packing 13 before being assembled to the stem 7 is a substantially circular shape. A material of the packing 13 is an elastic rubber. When the packing 13 is assembled to the stem pipe 7, the packing 13 is interposed between the surface 6f of the shaft portion and the first surface 7d. The packing 13 is interposed between the surface 6f of the shaft portion and the first surface 7d, and a cross-sectional shape of the packing 13 becomes substantially a quadrangle as shown in FIG. 2.

A shape of the metal ring 14 is a ring shape. A material of the metal ring 14 is preferably a metal having rigidity and that is not easily corroded. In the present embodiment, for example, titanium or a titanium alloy is used for the metal ring 14 and the stem pipe 7. Alternatively, stainless steel may be used for the metal ring 14 and the stem pipe 7. In the present embodiment, for example, titanium or titanium alloys are also used for materials of the winding stem 9, the body 2, the crown 6, the first C-ring 11, and the second C-ring 12. Stainless steel may be used for the materials of the winding stem 9, the body 2, the crown 6, the first C-ring 11, and the second C-ring 12.

A position of the packing 13 is restricted by the metal ring 14 and a third surface 7g of the stem pipe that faces the metal ring 14 with the packing 13 interposed therebetween, and the packing 13 is in a compressed state between the first surface 7d of the stem pipe 7 and the surface 6f of the shaft portion, so that required water resistantness can be ensured. Unlike the known water resistant structure in which there is a risk of the packing holding ring coming off in the deep sea because the packing holding ring made of a synthetic resin is used, by using the metal ring 14, the metal ring 14 does not come off even in the deep sea, so that water resistantness can be reliably ensured. Further, by using the metal ring 14 having higher mechanical strength than a synthetic resin, the water resistant structure can be miniaturized. Therefore, the watch 1 having a compact size and excellent water resistant structure can be provided.

In a state in which no force is applied to the packing 13, a cross-section of the packing 13 is substantially circular. A diameter of the packing 13 is defined as a thickness 17 of the packing. The thickness 17 of the packing is larger than the first distance 15. The packing 13 is in a compressed state between the first surface 7d of the stem pipe 7 and the surface 6f of the shaft portion, and a desired crushing allowance can be obtained, and thus the necessary water resistantness can be ensured.

In the cross-sectional view of the cross-section passing through the axis 6g of the shaft portion, the stem pipe 7 has the third surface 7g that faces the metal ring 14 with the packing 13 interposed therebetween. A distance between the third surface 7g and the metal ring 14 is defined as a third distance 19. The third distance 19 is larger than the thickness 17 of the packing. When the packing 13 is compressed between the first surface 7d of the stem pipe 7 and the surface 6f of the shaft portion, a space in which the packing 13 deforms can be secured.

As shown in FIG. 3, the metal ring 14 has an inner surface 14a and an outer surface 14b. The inner surface 14a is a surface facing the packing 13. The outer surface 14b is a surface facing the head portion 6a of the crown 6. The metal ring 14 includes a first opening 14c serving as an opening and a second opening 14d serving as an opening. The metal ring 14 includes an inclined surface 14e between the first opening 14c and the second opening 14d. The shaft portion 6b of the crown 6 is inserted through the first opening 14c and the second opening 14d.

The first opening 14c is an opening of the inner surface 14a. The second opening 14d is an opening of the outer surface 14b. A diameter of the first opening 14c is defined as a first diameter 21. A diameter of the second opening 14d is defined as a second diameter 22. The second diameter 22 is larger than the first diameter 21.

The inclined surface 14e is provided between the first opening 14c and the second opening 14d. The inclined surface 14e changes a diameter of the opening from the second diameter 22 of the outer surface 14b to the first diameter 21 of the inner surface 14a.

When the packing 13 is replaced for after-sales service, the packing 13 can be easily taken out of and inserted into the larger opening of the outer surface 14b through the inclined surface 14e. Specifically, a tip of a rod that is bent is inserted between the third surface 7g and the packing 13, and the packing 13 is hooked on the tip of the rod and taken out. Since the second opening 14d is wider than the first opening 14c, it is easy to operate the rod.

An object obtained by combining the stem pipe 7 and the metal ring 14 is referred to as a packing box 24. When the packing 13 is disposed in the packing box 24, the packing 13 is pressed in with a rod. The packing 13 is slid along the inclined surface 14e, and the operator passes the packing 13 through the first opening 14c. At this time, since the inclined surface 14e is a guide surface for moving the packing 13, the packing 13 can be easily inserted between the inner surface 14a of the metal ring 14 and the third surface 7g. For this reason, the packing box 24 can easily replace the packing 13.

The first diameter 21 of the first opening 14c of the metal ring 14 is larger than a third diameter 25 serving as a diameter of the insertion hole of the stem pipe 7. The insertion hole 7a is positioned deeper than a place at which the packing 13 is disposed when viewed from the head portion 6a side of the crown 6. When the packing 13 degrades, the packing 13 is replaced for after-sales service. At the time of replacing the packing 13, it is performed in a state in which the metal ring 14 is fixed to the stem pipe 7. The first opening 14c that is the opening at the place at which the packing 13 is installed is larger than the insertion hole 7a. Therefore, when the packing 13 is replaced in the after-sales service, the packing 13 can be easily replaced.

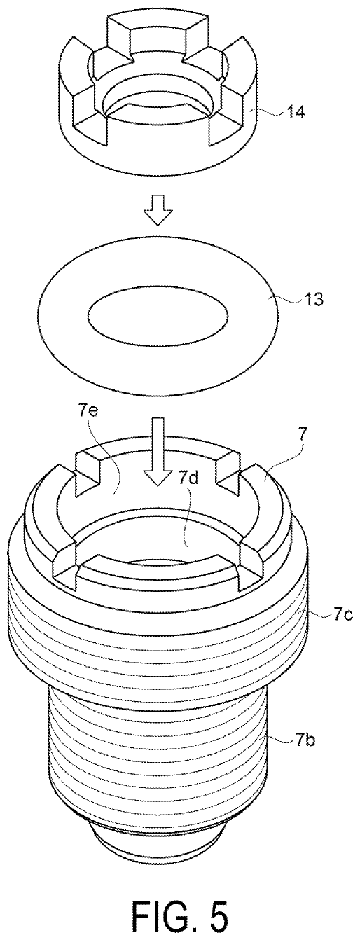

A procedure for assembling the stem pipe 7, the packing 13, and the metal ring 14 will be described. As shown in FIG. 5, the packing 13 is inserted to come into contact with the first surface 7d of the stem pipe 7. Next, the metal ring 14 is press-fitted into the second surface 7e. As a result, as shown in FIG. 4, the packing 13 and the metal ring 14 are disposed in the stem pipe 7.

The stem pipe 7 and the metal ring 14 include first grooves 7f and second grooves 14f on the head portion 6a side of the crown 6, respectively. The first grooves 7f and the second grooves 14f extend in two orthogonal directions. The metal ring 14 is disposed in the stem pipe 7 such that the first grooves 7f and the second grooves 14f overlap each other. When the stem pipe 7 is screwed and fixed to the body 2, a tip of a screwdriver is inserted into the first grooves 7f and the second grooves 14f to rotate the stem pipe 7. Therefore, the packing box 24 can be easily screwed onto the body 2.

Next, the metal ring 14 is fixed to the stem pipe 7 by caulking or welding at an end portion 7h of the head portion 6a side of the crown 6. In FIG. 4, the metal ring 14 is fixed to the stem pipe 7 by welding. The stem pipe 7 may be plastically deformed by caulking to fix the metal ring 14. The metal ring 14 can be firmly fixed to the stem pipe 7 by caulking or welding.

The packing box 24 is configured of two parts of the stem pipe 7 and the metal ring 14. When the stem pipe 7 and the metal ring 14 are formed into one body, a dedicated bite is required to process the first surface 7d with a lathe. Since this bite has a special shape, maintenance of the bite takes many man-hours. When the stem pipe 7 and the metal ring 14 are separate members, a bite can be inserted from the head portion 6a side of the crown 6 to process the first surface 7d of the stem pipe 7. Therefore, the first surface 7d can be easily formed with a normal bite.

In the packing box 24, a length obtained by adding the third distance 19 and a width of the metal ring 14 can be shortened. Since the head portion 6a of the crown 6 can be made smaller, the packing box 24 can be used not only for a diver's watch but also for a general water resistant watch. Additionally, the packing 13 is configured to be accommodated in a space formed by the first surface 7d and the third surface 7g of the stem pipe 7 and the inner surface 14a of the metal ring 14, so that the watch can be designed without changing the diameter of the shaft portion 6b of the crown 6 even when the thickness of the packing 13 is changed in accordance with requirements of water resistant performance. That is, according to the present embodiment, a case does not need to be increased in size because it is not necessary to increase the diameter of the shaft portion 6b in order to realize excellent water resistant performance, so that the watch 1 including the water resistant structure which is compact and can achieve excellent water resistant performance can be provided.

What is claimed is:

1. A watch comprising:
a crown including a head portion and a shaft portion;
a stem pipe including a first surface that includes an insertion hole through which the shaft portion is inserted and has a distance from a surface of the shaft portion as a first distance in cross-sectional view, and a second surface that is provided at a position closer to an end portion of the insertion hole than the first surface is and has a distance from the surface of the shaft portion as a second distance larger than the first distance;
a packing disposed between the surface of the shaft portion and the first surface; and
a metal ring that is disposed between the surface of the shaft portion and the second surface and faces the packing.

2. The watch according to claim 1, wherein
a thickness of the packing is larger than the first distance.

3. The watch according to claim 1, wherein
the stem pipe has a third surface that faces the metal ring with the packing interposed therebetween in cross-sectional view, and
a distance between the third surface and the metal ring is larger than a thickness of the packing.

4. The watch according to of claim 1, wherein
the metal ring has a ring shape and has an inner surface facing the packing and an outer surface facing the head portion of the crown, and
a diameter of an opening of the metal ring through which the shaft portion of the crown is inserted is a first diameter on an inner surface thereof, and is a second diameter larger than the first diameter on an outer surface thereof.

5. The watch according to claim 4, wherein
the first diameter of the opening of the metal ring is larger than a diameter of the insertion hole in the stem pipe.

6. The watch according to claim 1, wherein
the metal ring is fixed to the stem pipe by caulking or welding at an end portion of the stem pipe on a side of the head portion of the crown.
